(19) United States
(12) Patent Application Publication
(10) Pub. No.: US 2002/0196786 A1
(43) Pub. Date: Dec. 26, 2002

(54) Method and apparatus for data transmission

(76) Inventors: Josef Laumen, Hildesheim (DE); Sabine Van Niekerk, Salzgitter (DE)

Correspondence Address: Bell, Boyd & Lloyd LLC, P.O. Box 1135, Chicago, IL, 60690, US

(21) Appl. No.: 10/165,134

(22) Filed: Jun. 6, 2002

(30) Foreign Application Priority Data
Jun. 6, 2001 (DE) 101 27 361.4

(51) Int. Cl. H04Q 7/24

(52) U.S. Cl. 370/392; 370/338

(57) ABSTRACT

In order for a method, an apparatus, a transmitting and/or receiving unit and a communications system to provide increased convenience for each user with a greater level of flexibility for matching to different standards within the communication process, the present invention proposes that an IP address of a respective user be stored as organizational data in a data storage area, and be loaded automatically when required.

### BACKGROUND OF THE INVENTION

It is known that organizational data must be processed in order to set up and/or to maintain a communication path for transmission of data in any desired format and with any desired content from, via or to a subscriber terminal. Ever greater efforts are being made in data transmission for combining mobile communication in words and in any other form of data on the basis of all the Standards in order for it to be possible to transmit multimedia messages MM via a multimedia messaging service MMS. In addition to their mobile speech transmission, mobile radios are also being provided with Internet access. In a communications system such as the Internet, each host and each router has its own address based on the Internet protocol, the so-called IP address, which now must be processed and/or administered in addition to the known identifications for a mobile radio connection. The IP address contains a network number and a host number, in coded form. Each combination is unique and unambiguous as an IP address. As such, it is impossible for two hosts or routers to exist which have the same IP address.

In the Standard according to Ipv4, IP version 4, the IP address includes a 32-bit or 4-octet address field. This address can be subdivided into two parts:

a network part, which identifies the network to which the host belongs; and

host part, which identifies the host itself.

Hosts which are connected to the same network must have the same part for identification of the network, but differ by having different bits in the respective host part of their address. IP addresses are normally written in decimal notation, subdivided by decimal points. The decimal value of each of the four octets is indicated by separate decimal points in the following text. As an example, the 32-bit IP address which is represented in binary form by 11000011.00100010.00001100.00000111 is subsequently written as 195.34.12.7, in decimal form. It is self-evident that, as the number of Internet users rises, an IP address with a length of only 32 bits will not be sufficient to allow each subscriber to be assigned his/her own individual identification.

According to the Ipv6 Standard, that is to say IP version 6, IP addresses will have four times the length of the 32-bit Ipv4 address, namely 128 bits. Thus, it will be possible in the near future for a certain period of time to assign each mobile user his/her own IP address, which is unique and unambiguous, for using the IP protocol for mobile communication.

However, another disadvantage which remains in this context is that one user will be using a large number of different communication devices, which each require their own types of identification. At the moment, no capability is being identified for a simple, or even automatic, change to communication devices.

### SUMMARY OF THE INVENTION

The present invention is, therefore, directed toward a method and an apparatus, which provide improved convenience for each user, with a greater level of flexibility for matching to different standards within communication.

A method according to the present invention for data transmission includes the process of storing a specific IP address for a respective user as organizational data, so that the IP address can be loaded automatically, when required. A development of the present invention proposes that the IP address of a user is stored on an intelligent memory card, rather than on some undefined type of data storage. According to the present invention, a change to a communication appliance or subscriber terminal can thus be made in a very simple manner, by replacing the memory card, or taking it from a subscriber terminal and inserting it into another subscriber terminal.

A smart card such as a subscriber identity module or SIM card or UMTS subscriber identity module or USIM application is advantageously provided as an intelligent memory card. These data stores are intended by definition to be inserted into a mobile telephone. Such cards are known per se although, at the moment, a SIM or USIM has no memory capability provided on the UICC or on any other medium for its own IP address.

One advantage of this proposal is that the IP address will be available in the same way for a user irrespective of which subscriber terminal or which physical access he/she chooses for communication. According to the present invention, physical access has thus become freely variable; that is to say, a user can use any mobile terminal, even with any conceivable extension similar to a computer, with only one intelligent memory card in a format which has already been proven and is widely used. A further advantage is that a SIM or UICC is always available in each individual GSM or UMTS telephone. As such, the present invention ensures that a data format which is used for storing an IP address, and a mechanism for calling this data from any individual IP-compatible GSM or UMTS telephone will be understood independently of a respective manufacturer, since the data formats and calling conditions for the SIM and USIM/UICC are standardized, and are already available in the equipment.

According to the GSM Standard, the intelligent memory cards provided according to the present invention are referred to as subscriber identity modules SIM while, in contrast, in the UMTS, a distinction is drawn between the physically existing card, which is referred to as the universal IC card UICC, and its logical function, which is referred to as the UMTS subscriber identity module USIM. According to the present invention, an IP address is thus stored in a SIM card or in the USIM application on a UICC card. Second-generation mobile communications services, such as those according to the Global System for Mobile Communication Standard GSM, and the third generation, such as according to the Universal Mobile Telecommunication Service Standard UMTS, use precisely specified smart cards in addition to the mobile telephones. When inserted into a mobile telephone, these smart cards allow a user to use a communications service with which he/she is registered. Furthermore, user preferences and settings such as personal information about the user already can be stored on such a smart card. To this extent, an already existing infrastructure for subscriber terminals is used according to the present invention, and the functional scope of intelligent memory cards which are known per se is advantageously extended such that it will now be possible for any user to make any desired change to the subscriber terminals, independently of the equipment type and manufacturer.

Additional features and advantages of the present invention are described in, and will be apparent from, the following detailed description of the invention and the Figures.

### BRIEF DESCRIPTION OF THE FIGURES

FIG. 1 shows a schematic illustration of the organization of a data store.

FIG. 2 shows an illustration of a data store structure for storing an IP address on a USIM.

FIG. 3 shows an example of an elementary file EF_{IPS} for storing an IP address of a registered user.

### DETAILED DESCRIPTION OF THE INVENTION

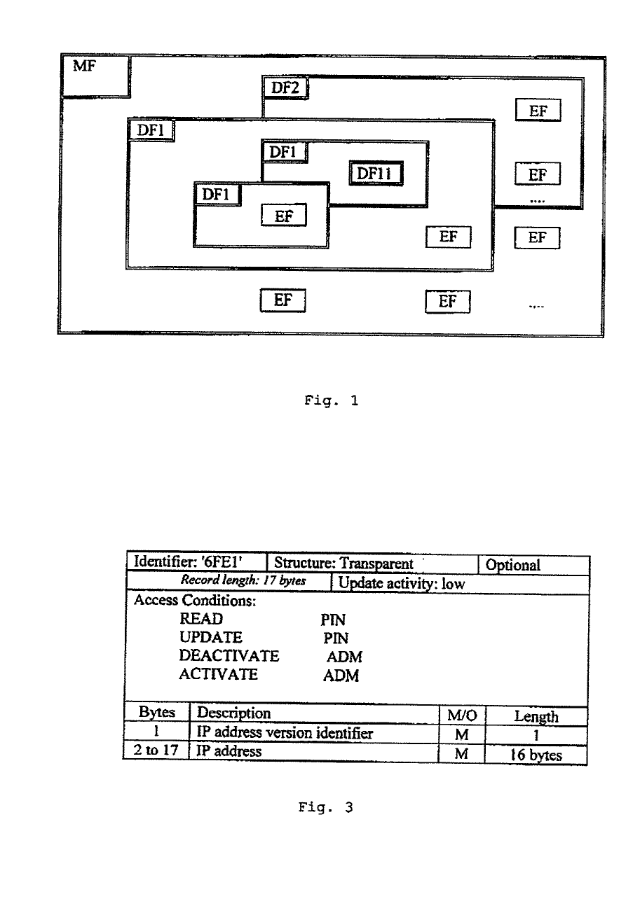

Elements and fields with the same function and method of operation are each provided with the same reference symbols and abbreviations in FIGS. 1 to 3.

In order to store different information, the data store on an intelligent memory card is organized with a hierarchical structure, as is shown in FIG. 1. This contains three different types of files; namely, a main file or master file MS, dedicated or reserved files DS, and elementary files EF. These files may be either organization-specific or application-specific. An operating system organizes access to the data stored in the various files. Security barriers and access restrictions for data evaluation and/or for amendments to the stored data are also provided, in a manner known per se, therein. In particular, data is released only after entering a correct personal identification number PIN.

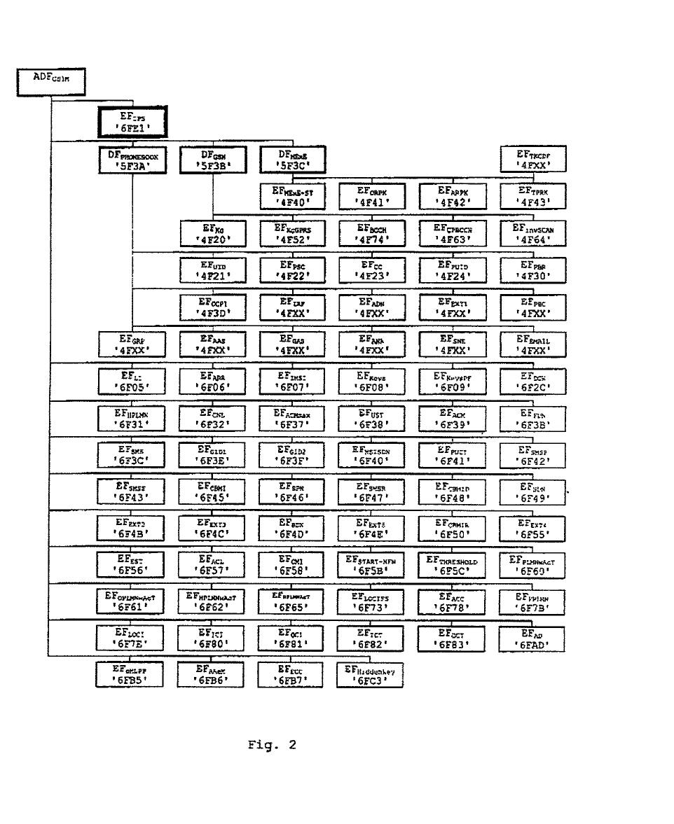

When an IP address is stored in a SIM card or in the USIM application on a UICC card, the IP address may be stored in an elementary file EF. FIG. 2 shows an IP address being stored in a UTMS-USIM. A USIM elementary file is reserved for the IP address. The relevant EF cell is accessed only on an application-specific or task-oriented basis using an internal structure; that is to say, only in the event of setting up or some other organization of an Internet access.

FIG. 3 shows an example of an elementary file EF_{IPS} for the USIM for storing an IP address, that is to say the IP address of a registered user. The elementary file EF_{IPS} contains a pointer for the version of the IP address, the IP address version identifier. The pointer for the version of the IP address includes the information about whether an IP address based on IP version 4 or IP version 6 is being used. In this exemplary embodiment, the version field is coded as

00:IP version 4

01:IP version 6

Furthermore, the IP address of the registered user is contained in the elementary file EF_{IPS}. In this case, the IP address uses hexadecimal coding. As illustrated in FIG. 3, the details of the IP address version and of the IP address are specified via an M as being mandatory.

Even in the case of dynamic allocation of an IP address for a respective Internet sitting, etc., the necessary information can, according to the present invention, be stored in a slightly modified manner in the memory card, on a personal basis and securely.

Since the memory card is designed in accordance with a standardized format, it can be used directly in virtually all normal mobile subscriber terminals. If necessary, it can at least partially be held, using known adapter elements, in a device in which it is read and/or written to; that is to say, in a card reader. However, according to the present invention, this card reader is preferably designed such that, firstly, it guarantees permanent and protective storage with secure writing/reading processes while, secondly, the memory card can be changed or removed by an authorized person simply, quickly and without any problems.

Although the present invention has been described with reference to specific embodiments, those of skill in the art will recognize that changes may be made thereto without departing from the spirit and scope of the present invention as set forth in the hereafter appended claims.

Further background details can be found, in particular, in the following references:

1. 3GPP TS 31.102 V3.3.0 (Release 1999), Characteristics of the USIM Application.

2. 3GPP TS 11.11 V8.4.0 (Release 1999), Specification of the Subscriber Identity Module-Mobile Equipment (SIM-ME) Interface.

3. 3GPP TS 31.101 V3.3.0, UICC-Terminal Interface; Physical and Logical Characteristics.

4. ETSI TS 102.221 V3.0.0, UICC-Terminal Interface; Physical and Logical Characteristics.

5. W. Rankl, W. Effing, Smartcard Handbook, John Wiley & Sons, second edition, 2000.

6. Wolfgang Rankl, Wolfgang Effing, Handbuch der Chipkarten [Manual of smartcards], Carl Hanser Verlag, 3rd Edition, 1999.

7. Douglas E. Cromer, Internetworking with TCP/IP, Volume 1: Principles, protocols, and architecture.

1. A method for data transmission, the method comprising the steps of:
storing an IP address of a respective user as organizational data in a data storage part;
automatically loading the IP address when required; and
processing the organizational data in order to at least one of set-up and maintain a communication path for the data transmission via a subscriber terminal.

2. A method for data transmission as claimed in claim 1, wherein an intelligent memory card is used as the data storage part.

3. A method for data transmission as claimed in claim 1, wherein the IP address of a respective user is stored in one of an SIM, a USIM or a UICC as an intelligent data store.

4. A method for data transmission as claimed in claim 1, wherein the IP address of the respective user is stored in a structured data store.

5. A method for data transmission as claimed in claim 4, wherein the IP address of the respective user is stored in an elemental file in the structured data store.

6. A method for data transmission as claimed in claim 1, the method further comprising the step of checking an access condition in the data storage part prior to at least one of the IP address and other data being enabled for at least one of reading and overwriting.

7. A method for data transmission as claimed in claim 1, wherein the IP address is stored together with a version field for coding an IP address version that is used.

8. A method for data transmission as claimed in claim 1, the method further comprising the step of producing files for storing further access data for other communications systems in the data storage part.

9. An apparatus for storing data, comprising an intelligent memory card for storing an IP address for a respective user as organizational data, wherein the IP address is automatically loaded when required, and the organizational data is processed in order to at least one of set-up and maintain a communication path for data transmission via a transcriber terminal.

10. An apparatus for storing data as claimed in claim 9, wherein the memory card is designed in accordance with a standardized format for use in substantially all normal mobile subscriber terminals.

11. An apparatus for storing data as claimed in claim 9, wherein the memory card is one of a SIM and a UICC card.

12. A transmission unit for at least one of transmitting and receiving, comprising:
and intelligent memory card for storing an IP address of a respective user as organizational data, wherein the IP address is loaded automatically when required, and the organizational data is processed in order to at least one of set-up and maintain a communication path for data transmission via a subscriber terminal; and
a device for at least partially holding the intelligent memory card, the device being used for at least one of reading and writing.

13. A transmission unit as claimed in claim 12, wherein the unit is a mobile telephone in accordance with at least one of a GSM Standard and a UMTS Standard.

14. A communications system for transmission of data in any desired format and with any desired content, comprising:
a transmission unit for at least one of transmitting and receiving and including both an intelligent memory card and a holding device, the intelligent memory card storing an IP address for a respective user as organizational data, wherein the IP address is loaded automatically when required and the organizational data is processed in order to at least one of set-up and maintain a communication path for data transmission, and the holding device at least partially holding the intelligent memory card and being for at least one of reading and writing; and
a subscriber terminal via which transmission of data occurs with the transmission unit.
